(19) United States
(12) Patent Application Publication
(10) Pub. No.: US 2026/0034618 A1
(43) Pub. Date: Feb. 5, 2026

(54) Method For Assembling An Anti-Adhesive Film Onto A Metal Substrate By Hot Stamping

(71) Applicant: SEB S.A., Ecully (FR)

(72) Inventors: Simon Allemand, Ecully Cedex (FR); Fabien Inclair, Ecully Cedex (FR); Patrice Rey, Ecully Cedex (FR); Martin Rubio, Ecully Cedex (FR)

(73) Assignee: SEB S.A., Ecully (FR)

(21) Appl. No.: 19/099,302

(22) PCT Filed: Jul. 28, 2023
(86) PCT No.: PCT/FR2023/051207

§ 371 Date: Jan. 28, 2025

(30) Foreign Application Priority Data
Jul. 29, 2022 (FR) FR2207868

(51) Int. Cl. B23P 11/00; A47J 36/02; B23K 20/00; B23P 15/00

(52) U.S. Cl. CPC B23P 11/00; A47J 36/02; B23K 20/002; B23P 15/00; B23P 2700/05

(57) ABSTRACT

A method for manufacturing a coated cooking element includes the following steps:
i. Providing a metal substrate and a metal mesh, the metal substrate having a face intended to be brought into contact with the metal mesh;
ii. Attaching the metal mesh to the face;
iii. Providing a film having a layer including one or more semi-crystalline or amorphous thermoplastic polymers, the layer configured to be brought into contact with the face and with the metal mesh;
iv. Heating the metal substrate and the metal mesh;
v. Positioning the film such that the layer is facing the face and the metal mesh;
vi. Assembling the metal substrate and the metal mesh with the film by hot stamping, the metal substrate and the metal mesh being at a temperature higher than the lowest of the melting points of the semi-crystalline thermoplastic polymers and the glass transition temperatures of the amorphous thermoplastic polymers of the layer at the time of assembly.

### FIELD OF THE INVENTION

The present invention relates to the field of methods for obtaining cooking elements coated with an anti-adhesive polymer film.

### STATE OF THE ART

In the industry of cookware comprising an anti-adhesive cooking surface, the performance of anti-adhesive coatings and the development of methods for obtaining such coatings are important concerns.

Conventionally, a metal substrate is first shaped to form a kitchen utensil, then the inner surface of the kitchen utensil is coated with a fluororesin having excellent heat resistance such as polytetrafluoroethylene (PTFE) or tetrafluoroethylene-perfluoroalkyl vinyl ether (PFA) by means of a liquid spray coating method or a powder coating method. An alternative is to coat the substrate then shape the substrate thus coated.

The liquid spray coating method has a number of disadvantages. When the metal substrate has a curved shape, it is difficult to obtain a uniform coating thickness. The liquid spray coating method also involves the use of solvents or volatile organic compounds that evaporate during the process and must be recovered and recycled. From an environmental point of view, a solvent-free and volatile organic compound-free method is preferred. On the other hand, the coating thickness is limited. Cracking is likely to occur when the coating thickness is too thick.

The powder coating method also has disadvantages. The resulting coating has pinhead-type defects that can lead to a reduction in anti-adhesive properties.

The coatings obtained according to these two methods may have significant surface roughness which can cause cleaning problems, as some cooking residues may persist on the surface of the coating even after several washes.

Faced with the mechanical stresses inherent in the use of culinary items, a loss of the mechanical properties of the coating is observed and delamination of the coating can occur at the interface with the metal substrate.

In order to overcome the above-mentioned disadvantages, the state of the art describes metal substrates coated with fluorinated films by lamination.

Patent application KR20150030719 describes a kitchen utensil comprising a body including a metal substrate on which a film of a fluorinated resin is laminated. A method for obtaining a kitchen utensil is also described. In example 1, a PTFE multilayer film is used without information on the nature of the layers. The operation of laminating the film on the substrate is not described.

Application KR20160099388 describes the method for obtaining a metal substrate coated with a fluorinated film (devoid of a primer layer comprising an organic compound or an adhesive). The fluorinated film is a multilayer film obtained by successive deposition on a support of an aqueous dispersion of the constituents of the layer (fluorinated resin and optionally an inorganic filler) which is dried and sintered. The multilayer film is then removed from its support and positioned on the metal substrate before assembly. The layer of the fluorinated film in contact with the metal is made of PTFE and a resin selected from FEP, PFA, TFM, MFA (or a mixture thereof) which has good flow properties, thus allowing good adhesion, which is not allowed by PTFE. The metal substrate/fluorinated film assembly is carried out by thermal compression, in a static press or between rollers (roll-to-roll method). In the static assembly method, both the substrate and the film are heated to a temperature comprised between 300° C. and 410° C. with an applied pressure of 100 to 800 psi (0.7 MPa to 5.6 MPa). In the roll-to-roll assembly method (difficult to implement when the metal substrate is of significant thickness), both the substrate and the film are heated to a temperature comprised between 330° C. and 420° C. with an applied pressure comprised between 2 and 15 MPa.

In both method variants, the pressure applied during assembly is a few MPa and the implementation temperature is limited by the degradation temperature of the fluorinated film (in particular of PTFE which begins at 420° C.). The assembly rates of the polymer film and the metal substrate are therefore limited by the parameters of the assembly method.

In addition, although the method for obtaining a substrate coated by lamination of a fluorinated film offers the possibility of having a thicker, and therefore more resistant, anti-adhesive coating, the mechanical properties of such a film are not, however, optimal.

### DISCLOSURE OF THE INVENTION

From an industrial point of view, there remains a need to develop methods for assembling a polymer film onto a metal substrate that are more advantageous in terms of assembly time and that allow to obtain more efficient coatings in terms of durability.

The applicant has thus developed a method for manufacturing a coated cooking element by hot stamping assembly of a metal substrate and a polymer film, said assembly comprising a metal reinforcing element between the metal substrate and the polymer film.

### SUMMARY OF THE INVENTION

The inventors have discovered that the method according to the invention allows to achieve rapid assembly between a metal substrate and a polymer film comprising one or more semi-crystalline or amorphous thermoplastic polymers while ensuring good adhesion of the polymer film to said metal substrate.

Unlike the usual method for assembling fluoropolymer films on metal such as hot pressing, only the substrate is advantageously heated prior to assembly according to the method of the present invention. The polymer film is heated essentially by conduction when brought into contact with the substrate at the time of assembly, then is cooled due to the thermal inertia of the assembly tools which remain at a temperature lower than the heating temperature of the metal substrate.

During assembly, it is thus possible to heat very locally, in particular at the substrate-film interface, the polymer film comprising one or more semi-crystalline or amorphous thermoplastic polymers to a temperature above the melting temperature or the glass transition temperature of all or part of the thermoplastic polymers for a very short time, which does not cause degradation of the film.

The implementation of this high temperature combined with the pressure applied during the stamping allows the assembly of the polymer film and the metal substrate to be carried out in a much shorter time than according to conventional methods of assembling polymer films on metal substrates such as hot pressing.

Furthermore, a metal reinforcement in the form of a metal mesh is attached to the metal substrate before assembly with the polymer film. The presence of this reinforcement allows to improve the mechanical properties of the coated metal substrate. The cohesion between the metal substrate and the polymer film is thereby reinforced. The metal reinforcement allows in particular to improve the performance of the anti-adhesive cooking surface, in particular by increasing the resistance of the anti-adhesive coating to scratches.

The invention thus relates to a method for manufacturing a coated cooking element (1) comprising the following steps:
i. Providing a metal substrate (2) and a metal mesh (3), said metal substrate (2) having a face (2a) intended to be brought into contact with said metal mesh (3);
ii. Attaching said metal mesh (3) to said face (2a) of said metal substrate (2);
iii. Providing a film (4), said film (4) comprising a layer (4a) comprising one or more semi-crystalline or amorphous thermoplastic polymers, said layer (4a) being intended to be brought into contact with said face (2a) of said metal substrate (2) and with said metal mesh (3);
iv. Heating said metal substrate (2) and said metal mesh (3);
v. Positioning said film (4) such that the layer (4a) is facing said face (2a) of said metal substrate (2) and said metal mesh (3) which were heated in step iv.;
vi. Assembling said metal substrate (2) and said metal mesh (3) with said film (4) by hot stamping, said metal substrate (2) and said metal mesh (3) being at a temperature higher than the lowest of the melting points of the semi-crystalline thermoplastic polymers and the glass transition temperatures (Tg) of the amorphous thermoplastic polymers of the layer (4a) at the time of assembly.

The invention also relates to a method for shaping a coated cooking element as described above comprising a step (a) of press-forming the coated cooking element (1) obtained at the end of step (vi).

Other aspects of the invention are as described below and in the claims.

### Definitions

The term “film” is understood to mean, within the meaning of the present invention, a set consisting of one or more superimposed layers intended to be assembled with the metal substrate. The term “film” also corresponds to said set once assembled with the metal substrate.

The term “layer” is understood to mean, within the meaning of the present invention, a continuous layer. A continuous layer (or also called a monolithic layer) is a single whole forming a total flat area completely covering the surface on which it is placed or is to be placed.

For the purposes of the present invention, the term “hot stamping” means the method for assembling the previously heated metal substrate (2) and metal mesh (3) and the polymer film (4) between a lower tool and an upper tool.

For the purposes of the present invention, the term “aluminum alloy” means an aluminum alloy of series 1000, 2000, 3000, 4000, 5000, 6000, 7000 and 8000.

### DESCRIPTION OF THE FIGURES

FIG. 1 shows a sectional view of an exemplary embodiment of a coated cooking element (1), including a metal substrate (2), a metal mesh (3) and a film (4), before assembly according to the method of the invention.

FIG. 2 shows a metal mesh (3) made of woven metal which can be used according to the method of the invention.

FIG. 3 shows a metal mesh (3) made of expanded metal which can be used according to the method of the invention.

FIG. 4 shows a sectional view of exemplary embodiments of a coated cooking element (1), including a metal substrate (2), a metal mesh (3) and a film (4).

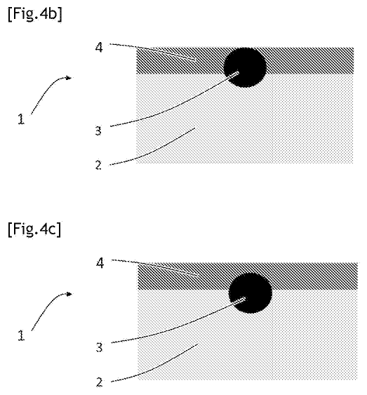

In FIG. 4a, the metal mesh (3) is fully crimped into the metal substrate (2).

In FIG. 4b, the metal mesh (3) is only partially crimped into the metal substrate (2) and the surface of the metal mesh (3) emerges on the surface of the film (4), that is to say, the film (4) does not cover the entire metal mesh (3).

In FIG. 4c, the metal mesh (3) is only partially crimped into the metal substrate (2) and the surface of the metal mesh (3) is completely covered by the film (4).

### DETAILED DESCRIPTION OF THE INVENTION

The inventors have developed a manufacturing method that meets the expressed needs.

The invention thus relates to a method for manufacturing a coated cooking element (1) comprising the following steps:
i. Providing a metal substrate (2) and a metal mesh (3), said metal substrate (2) having a face (2a) intended to be brought into contact with said metal mesh (3);
ii. Attaching said metal mesh (3) to said face (2a) of said metal substrate (2);
iii. Providing a film (4), said film (4) comprising a layer (4a) comprising one or more semi-crystalline or amorphous thermoplastic polymers, said layer (4a) being intended to be brought into contact with said face (2a) of said metal substrate (2) and with said metal mesh (3);
iv. Heating said metal substrate (2) and said metal mesh (3);
v. Positioning said film (4) such that the layer (4a) is facing said face (2a) of said metal substrate (2) and said metal mesh (3) which were heated in step iv.;
vi. Assembling said metal substrate (2) and said metal mesh (3) with said film (4) by hot stamping, said metal substrate (2) and said metal mesh (3) being at a temperature higher than the lowest of the melting points of the semi-crystalline thermoplastic polymers and the glass transition temperatures (Tg) of the amorphous thermoplastic polymers of the layer (4a) at the time of assembly.

Advantageously, steps i. to vi. are carried out successively.

### Metal Substrate (2) Used in Step i of the Method

As metal substrates (2) which can be used in the context of the invention, mention may advantageously be made of substrates made of aluminum, stainless steel, cast iron or aluminum, or titanium or copper.

For the purposes of the present invention, aluminum means a metal consisting of 100% aluminum or an aluminum alloy.

Advantageously, the metal substrate (2) is an aluminum substrate, a stainless steel substrate or a multilayer, in particular two-layer or three-layer metal substrate, these multilayers being able to be obtained for example by co-lamination, by hot diffusion under load (solid state bonding) or by hot or cold stamping (impact bonding).

Preferably, the metal substrate (2) comprises an alternation of layers of metal and/or metal alloy.

According to one embodiment, the metal substrate (2) is an aluminum alloy substrate, a stainless steel substrate or a multilayer metal substrate whose face (2a) is made of aluminum alloy or stainless steel.

Preferably, the metal substrate (2) is an aluminum substrate.

Advantageously, the thickness of the metal substrate (2) is comprised between 0.5 mm and 10 mm.

Advantageously, the face (2a) of the metal substrate (2) has undergone a surface treatment prior to assembly with the film (4) allowing to improve the adhesion of said film to said substrate.

According to one embodiment, the surface of the face (2a) of the metal substrate (2) has undergone a surface treatment, said surface treatment being a chemical attack, brushing, hydration, sandblasting, shot peening, a physicochemical treatment of the plasma or corona or laser type, a chemical activation or a combination of these different techniques.

### Metal Mesh (3) Used in Step i of the Method

Metal mesh means not only a metal mesh made of wires crossing each other but also a perforated metal sheet with holes or else an expanded metal mesh.

Advantageously, the metal mesh (3) is a woven metal mesh or an expanded metal mesh, preferably made of stainless steel.

The metal mesh (3) can have a thickness comprised between 50 μm and 800 μm, preferably between 150 μm and 500 μm.

Thus, when the metal mesh (3) is woven, the wires can have a diameter (or thickness) comprised between 50 μm and 800 μm, preferably between 150 μm and 500 μm.

When the metal mesh (3) is made of expanded metal, the mesh may have a thickness comprised between 50 μm and 800 μm, preferably between 150 μm and 500 μm.

When the metal mesh (3) is woven, the metal wires woven in the same direction are advantageously spaced from each other between 0.2 mm and 8 mm.

The pattern, that is to say, the empty areas in the woven metal mesh or in the expanded metal mesh, may all be identical or, on the contrary, different.

FIGS. 2 and 3 respectively show a woven metal mesh and an expanded metal mesh that can be used in the context of the present invention.

The metal mesh (3) has a dimension less than or equal to that of the metal substrate (2).

According to one embodiment, the metal mesh (3) has undergone a surface treatment, said surface treatment being a chemical attack, brushing, hydration, sandblasting, shot peening, a physicochemical treatment of the plasma or corona or laser type, a chemical activation or a combination of these different techniques.

### Step (ii) of Attaching the Metal Mesh (3) to the Face (2a) of the Metal Substrate (2)

The metal mesh (3) is applied to the face (2a) of the metal substrate (2).

The metal mesh (3) is attached to the face (2a) by means of attachment points or by die-stamping to embed it at least partially in the surface of the metal substrate (2).

Attaching the metal mesh (3) by attachment points, means the metal mesh (3) pre-crimped on the metal substrate (2) at a few points and not over its entire surface in contact with the metal substrate (2). This attachment allows to position said metal mesh (3) on said metal substrate (2) for the subsequent steps of the method.

Advantageously, the attachment of the metal mesh (3) to the face (2a) of the metal substrate (2) is obtained by die-stamping to embed said metal mesh (3) at least partially in said face (2a).

Die-stamping means an operation which consists of stamping, for example with a drop hammer or a punch using a press, or strongly pressing, for example by means of a surface or a roller, on the metal mesh (3) to embed it at least partially in the surface of the metal substrate (2).

Unlike attachment by anchor points, the die-stamping operation is carried out over the entire surface of the metal mesh (2).

Advantageously, the die-stamping operation is carried out using a press at room temperature.

The depth of the metal mesh (3) depends on the force applied during die-stamping, the relative hardnesses of the metals of the metal mesh (3) and the metal substrate (2), and characteristics such as the diameter of the wires of the metal mesh (3).

According to one embodiment, the metal mesh (3) is only partially embedded in the surface of the metal substrate (2) and constitutes protrusions.

According to another embodiment, the metal mesh (3) is completely embedded in the surface of the metal substrate (2).

When the metals of the metal mesh (3) and the metal substrate (2) are different, die-stamping can create a composite substrate having properties resulting from those of the two metals. Thus, if the metal mesh (3) is made of a harder metal than the metal substrate (2), the mechanical properties of the base metal will be modified, such as its tendency to deform when hot, which will be reduced.

The metal mesh (3) after attachment on the metal substrate (2) can create a structuring of the surface allowing to increase the contact surface with the film (4) and thus improve the cohesion of the assembly.

The metal substrate (2) and metal mesh (3) set may undergo a surface treatment after the attachment step, said surface treatment being a chemical attack, brushing, hydration, sandblasting, shot peening, a physicochemical treatment of the plasma or corona or laser type, a chemical activation or a combination of these different techniques.

Advantageously, the average arithmetic roughness Ra of the surface of the face (2a) of the metal substrate (2) is greater than or equal to 1 μm, preferably greater than or equal to 2 μm.

Advantageously, the average arithmetic roughness Ra of the surface of the face (2a) of the metal substrate (2) is less than or equal to 20 μm.

Advantageously, the average arithmetic roughness Ra of the surface of the face (2a) of the metal substrate (2) ranges from 2 μm to 10 μm.

The average arithmetic roughness Ra is measured using a roughness meter according to standard ISO 4287. Ra represents the arithmetic average of the deviations from the average. The surface topography can be studied in particular with a profilometer with a probe equipped with a fine stylus equipped with a diamond tip, or with an optical metrology apparatus such as Altisurf®, in which a chromatic confocal sensor allows a non-contact measurement. The study of this surface topography allows to define the average arithmetic roughness Ra.

### Film (4) Used in Step iii of the Method

The film (4) comprises a layer (4a) comprising one or more semi-crystalline or amorphous thermoplastic polymers, said layer (4a) being intended to be placed in contact with said face (2a) of said metal substrate (2) and with said metal mesh (3).

The melting point of semi-crystalline thermoplastic polymers and the glass transition temperature (Tg) of amorphous thermoplastic polymers in the film (4) can be determined by thermal analysis methods such as Differential Thermal Analysis (or DSC for Differential Scanning Calorimetry) or Dynamic Mechanic Analysis (DMA).

According to one embodiment, the film (4) comprises a single layer (4a) comprising one or more semi-crystalline or amorphous thermoplastic polymers forming a cooking face (5).

According to another configuration, the film (4) further comprises one or more layers each comprising one or more semi-crystalline or amorphous thermoplastic polymers.

According to one embodiment, the semi-crystalline or amorphous thermoplastic polymer(s) of the layer (4a) and, where appropriate, of the additional layer(s) of the film (4), which are identical or different, are selected from the group comprising:
polytetrafluoroethylene (PTFE), tetrafluoroethylene and perfluoropropylvinyl ether (PFA) copolymers, tetrafluoroethylene and hexafluoropropene (FEP) copolymers, polyvinylidene fluoride (PVDF), tetrafluoroethylene and polymethylvinyl ether (MVA) copolymers, tetrafluoroethylene terpolymers, polymethylvinyl ether and fluoroalkylvinyl ether (TFE/PMVE/FAVE), ethylene tetrafluoroethylene (ETFE), and mixtures thereof;
polyarylether ketones (PAEK), including polyether ketone (PEK), polyether ether ketone (PEEK), polyether ketone ketone (PEKK), polyether ether ketone ketone (PEEKK), polyether ketone ether ketone ketone (PEKEKK), preferably polyether ether ketone (PEEK);
poly(phenylene oxide) (PPO), poly(arylethersulfone) polymers (PAES) including polyethersulfone (PES), polyphenylene ether sulfone (PPSU), poly(arylene sulfides) (PAS) including polyphenylene sulfide (PPS), liquid crystal polymers;
polyamideimide (PAI), polyimide (PI), polyetherimide (PEI), polybenzymidazole (PBI);
and mixtures thereof.

Also the film (4) may further comprise at least one filler and/or at least one reinforcement.

As fillers which can be used in the present invention, mention may in particular be made of metal oxides, metal carbides, metal oxynitrides, metal nitrides, silicas and mixtures thereof.

These fillers may be present in one or more layers of the film (4) or in each of the layers of the film (4).

As reinforcements that can be used under the present invention, mention may be made of a mineral or metal reinforcement of the fiber type, metal mesh, fiberglass material or fabric. The reinforcement may also consist of a non-fluorinated polymer with high thermomechanical properties of the polyaryletherketone (PEAK) type, such as for example polyetheretherketone (PEEK), or polyamide-imide (PAI). The reinforcement may be in the form of a layer of the film (4) positioned between the layer (4a) and the layer (4) forming the cooking face.

In order to improve the adhesion of the film (4) and the metal substrate (2), the layer (4a) of the film (4) coming into contact with the face (2a) of the metal substrate (2) and with the metal mesh (3) during step (vi) may have undergone a mechanical or chemical surface treatment. The surface treatment may be a chemical attack, brushing, hydration, sandblasting, shot peening, a physicochemical treatment of the plasma or corona or laser type, a chemical activation or a combination of these different techniques.

According to one embodiment, the thickness of said film (4) is comprised between 5 μm and 500 μm, preferably between 25 μm and 150 μm.

The thickness of the layer(s) of the film (4) is measured at 20 random points on the section of the film. The average thickness of said film (4) is obtained by averaging these 20 measurements.

The total thickness of the film (4) of the coated cooking element (1) according to the invention, that is to say measured on the cooking element once it has been coated with the film (4), is comprised between 5 μm and 500 μm, preferably between 25 μm and 150 μm.

The measurement of the thickness of the film (4) of the coated cooking element (1) according to the invention is carried out at 20 random points on the section of the coated substrate. The average thickness of said film (4) is obtained by averaging these 20 measurements.

The film (4), before assembly with the metal substrate (2), can be obtained by depositing a first layer on a support, then possibly by the successive deposition of the other layers, then by exfoliation of said film to separate it from the support. The layers of the film (4) can also be assembled together by any other assembly method, such as by lamination for example.

Generally, the film (4) of the coated cooking element (1) completely covers the face (2a) of the metal substrate (2), but it can be considered that only a part of the metal substrate (2) is covered.

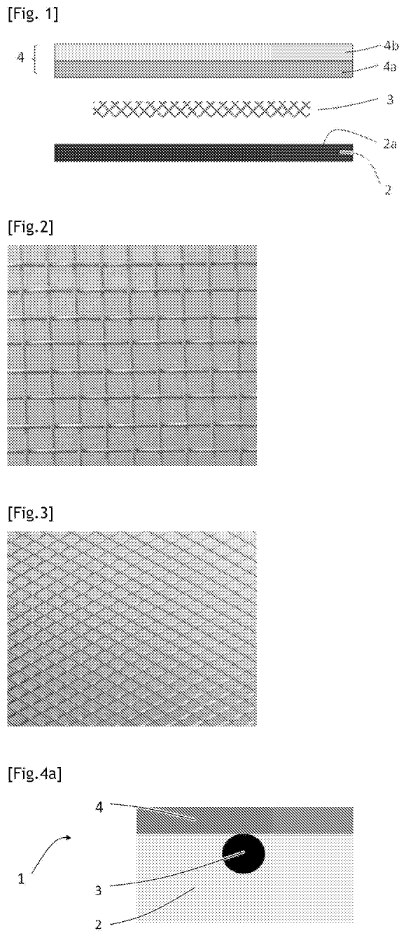

In the embodiment illustrated in FIG. 1, the film (4) includes 2 layers (4a, 4b).

### Step iv

The metal substrate (2) and the metal mesh (3) from step (ii) are heated in step iv prior to steps v and vi of the method. The metal substrate (2) and the metal mesh (3) can be heated by means of any suitable equipment, in a furnace or by induction for example.

### Step v

Before assembly in step vi, the film (4) is positioned above the metal substrate (2) so that its layer (4a) is facing the face (2a) of the metal substrate (2) and the metal mesh (3) previously heated in step iii.

The film (4) is positioned so that the entire surface of the layer (4a) simultaneously comes into contact with the surface of the face (2a) of the metal substrate (2) and the metal mesh (3) during the assembly step vi.

To ensure this contact, the film (4) can be attached to the upper tool or stretched between 2 rollers.

### Step vi

When assembling the metal substrate (2) and the metal mesh (3) with the film (4) by hot stamping, said metal substrate (2) and said metal mesh (3) are at a temperature higher than the lowest of the melting points of the semi-crystalline thermoplastic polymers and the glass transition temperatures (Tg) of the amorphous thermoplastic polymers of the layer (4a) at the time of assembly.

When the temperature at the time of assembly is lower than the lowest of the melting points of the semi-crystalline thermoplastic polymers and the glass transition temperatures (Tg) of the amorphous thermoplastic polymers of the layer (4a), the adhesion of the film (4) to the metal substrate (2) and the metal mesh (3) is not sufficient.

When the temperature is higher than 550° C., a degradation of the film (4) is observed.

When the layer (4a) comprises predominantly by weight PTFE among the semi-crystalline or amorphous thermoplastic polymers constituting it, the metal substrate (2) and the metal mesh (3) are at a temperature comprised between 350° C. and 550° C., preferably at a temperature comprised between 400° C. and 450° C. at the time of assembly with the film (4).

The temperature of the metal substrate (2) and the metal mesh (3) at the time of assembly corresponds to the temperature of the metal substrate (2) and the metal mesh (3) when stamping begins, that is to say, when pressurization of the metal substrate (2) and metal mesh (3)/film (4) set begins.

According to one embodiment, the assembly by hot stamping during step vi. is carried out by means of a hydraulic or mechanical press comprising a lower tool and an upper tool between which the metal substrate (2) and the metal mesh (3) are assembled with the film (4), said metal substrate (2) being preferentially in contact with the lower tool and said film (4) being preferentially in contact with the upper tool.

The surface of the lower tool, advantageously flat, can undergo a surface treatment so as to avoid any sticking of the metal substrate to said tool.

Advantageously, the plane of the surface of the upper tool, relative to the plane of the surface of the lower tool, has an angle comprised between 0.01° and 0.5°, preferably between 0.15° and 0.25°. This angle allows to limit the trapping of air during the assembly step.

Advantageously, the assembly tools are not heated prior to assembly step v.

Optionally, the lower tool can be heated. Optionally, the upper tool can be cooled.

According to one embodiment, the lower tool is heated to a temperature comprised between 25° C. and the temperature of the metal substrate (2) at the time of assembly and/or the upper tool is brought to a temperature comprised between 15° C. and 120° C. during step vi.

Unless otherwise stated, the temperature values indicated in this application correspond to measured temperature values and are not set temperatures.

The temperature values are measured by any suitable means, for example by means of a temperature probe positioned on the surface or in the mass of the heated or cooled element.

The temperature of the metal substrate (2) and the metal mesh (3) at the time of assembly corresponds to the temperature of the surface (2a) of the metal substrate (2) when the pressurization of the metal substrate (2) and metal mesh (3)/film (4) set begins.

The temperature of the metal substrate (2) and the metal mesh (3) can then drop during the stamping operation, particularly when the lower tool is not heated prior to the assembly step.

During the stamping operation of step vi, a pressure greater than or equal to 100 MPa, preferably several hundred MPa, is advantageously used.

According to one embodiment, the metal substrate (2), the metal mesh (3) and the film (4) are maintained under a pressure comprised between 100 MPa and 800 MPa, preferably between 350 MPa and 500 MPa during step vi.

The pressure applied during the stamping operation is considerably higher than that applied in conventional metal substrate/polymer film assembly methods such as hot pressing which is only a few MPa.

According to one embodiment, the duration of maintaining the metal substrate (2), the metal mesh (3) and the film (4) under pressure is less than or equal to 1 minute, preferably less than or equal to 15 seconds during step vi.

Stamping can be carried out by applying a sharp blow, for a duration of less than 5 seconds.

According to another embodiment, the duration of maintaining the metal substrate (2), the metal mesh (3) and the film (4) under pressure is comprised between 1 second and 1 minute, preferably between 2 seconds and 15 seconds during step vi.

The film (4) is essentially heated by conduction when it comes into contact at the time of assembly with the heated metal substrate (2) and the heated metal mesh (3). It is then cooled during stamping due to the thermal inertia of the assembly tools whose temperature is lower than the heating temperature of the metal substrate (2). The temperature of the film (4) can thus drop rapidly during the stamping operation, in particular when the lower tool is not heated prior to the assembly step.

The film (4) is advantageously not heated prior to assembly step vi.

According to the method of the invention, it is thus possible to heat the film (4) very locally, in particular at the metal substrate (2)-film (4) interface, to a temperature above the lowest of the melting points of the semi-crystalline thermoplastic polymers and the glass transition temperatures (Tg) of the amorphous thermoplastic polymers of the layer (4a) for a very short time, which does not cause any degradation of the film (4).

Advantageously, the temperature of the film (4) at the end of step vi. of assembling said film (4) with the metal substrate (2) and the mesh (3), that is to say when the assembly of the film (4), the metal substrate (2) and the mesh (3) is no longer maintained under pressure, is lower than the lowest of the melting points of the semi-crystalline thermoplastic polymers and the glass transition temperatures (Tg) of the amorphous thermoplastic polymers of the layer (4a).

The combination, at the time of assembly by stamping, of a temperature and a pressure as described above, allows to ensure the adhesion of the film (4) on the metal substrate (2) and the metal mesh (3) in very short times.

In step ii, the metal mesh (3) is attached to the face (2a) by means of attachment points or is at least partially embedded in the surface of the metal substrate (2).

Step vi of assembling the metal substrate (2) and the metal mesh (3) with the film (4) by hot stamping can also lead to a partial embedding of the metal mesh (3) in the surface of the metal substrate (2).

The presence of the metal mesh (3) helps to improve the performance of the anti-adhesive cooking surface, in particular by increasing the resistance of the anti-adhesive coating to scratches.

The metal mesh (3) can help limit the penetration of metal tools into the anti-adhesive coating, thus limiting the formation of scratches.

Due to the presence of the metal mesh (2), the cooking face (5) of the coated cooking element (1) may also have a surface texturing, with the formation of reliefs in the form of protrusions, for example.

These reliefs can allow to increase the resistance of the anti-adhesive coating to scratches, in particular when using metal tools which then come into contact mainly with the peaks of the reliefs of said cooking face (5).

FIG. 4 shows, purely for illustrative and non-limiting purposes, a sectional view of exemplary embodiments of a coated cooking element (1) according to the invention, including a metal substrate (2), a metal mesh (3) and a film (4).

In FIG. 4a, the metal mesh (3) is fully crimped into the metal substrate (2).

In FIG. 4b, the metal mesh (3) is only partially crimped into the metal substrate (2) and the surface of the metal mesh (3) emerges on the surface of the film (4), that is to say, the film (4) does not cover the entire metal mesh (3).

In FIG. 4c, the metal mesh (3) is only partially crimped into the metal substrate (2) and the surface of the metal mesh (3) is completely covered by the film (4).

According to a variant not shown, the metal mesh (3) is only partially crimped in the metal substrate (2) and the surface of the metal mesh (3) is entirely covered by the film (4). The surface of the film (4) after assembly is not flat due to the presence of the metal mesh and has reliefs in the form of protrusions.

The coated cooking element (1) may also have configurations of the assembly of the metal substrate (2), the metal mesh (3) and the film (4) that are not identical in the different areas of the coated cooking element (1). Thus, the metal mesh (3) may be completely crimped into the metal substrate (2) in some areas of the coated cooking element (1) and partially crimped into the metal substrate (2) in other areas of the coated cooking element (1).

After assembly, the metal substrate (2) and the metal mesh (3) coated with the film (4) are left to cool to room temperature in order to obtain maximum adhesion between the metal substrate (2), the metal mesh (3) and the film (4).

The metal substrate (2) coated with the film (4) can then be shaped at the end of step (vi).

A second object of the invention thus relates to a method for shaping a coated cooking element as described above comprising a step (a) of press-forming the coated cooking element (1) obtained at the end of step (vi).

The shaping method may further comprise a step (b) of stretching the coated cooking element (1) obtained at the end of step (a).

The adhesion of the film (4) to the metal substrate (2) before shaping must be good enough to avoid any loss of adhesion during and after the shaping operation.

The coated cooking element (1) according to the method of the invention can form a cooking container in a culinary article selected from the group consisting of saucepan, frying pan, skillets or fondue or raclette pots, stewpot, wok, sauté pan, crepe pan, grill, plancha, cooking pot, cocotte, culinary mold.

The coated cooking element (1) according to the method of the invention can form a cooking container in an electric cooking appliance selected from the group consisting of electric crepe maker, electric raclette appliance, electric fondue appliance, electric grill, electric plancha, electric cooker, cooking robot, bread maker. Thus the culinary article can form a cooking accessory for an electric cooking appliance.

1-20. (canceled)

21. A method for manufacturing a coated cooking element comprising the following steps:
i. Providing a metal substrate and a metal mesh, said metal substrate having a face intended to be brought into contact with said metal mesh;
ii. Attaching said metal mesh to said face of said metal substrate;
iii. Providing a film, said film comprising a layer comprising one or more semi-crystalline or amorphous thermoplastic polymers, said layer being intended to be brought into contact with said face of said metal substrate and with said metal mesh;
iv. Heating said metal substrate and said metal mesh;
v. Positioning said film such that the layer is facing said face of said metal substrate and said metal mesh which were heated in step iv.;
vi. Assembling said metal substrate and said metal mesh with said film by hot stamping, said metal substrate and said metal mesh being at a temperature higher than the lowest of the melting points of the semi-crystalline thermoplastic polymers and the glass transition temperatures (Tg) of the amorphous thermoplastic polymers of the layer at the time of assembly.

22. The method for manufacturing a coated cooking element according to claim 21, wherein the assembly by hot stamping during step vi. is carried out by means of a hydraulic or mechanical press comprising a lower tool and an upper tool between which the metal substrate and the metal mesh are assembled with the film.

23. The method for manufacturing a coated cooking element according to claim 22, wherein said metal substrate is in contact with the lower tool and said film is in contact with the upper tool.

24. The method for manufacturing a coated cooking element according to claim 22, wherein the metal substrate, the metal mesh and the film are maintained under a pressure comprised between 100 MPa and 800 MPa in step vi.

25. The method for manufacturing a coated cooking element according to claim 24, wherein the metal substrate, the metal mesh and the film are maintained under a pressure comprised between 350 MPa and 500 MPa in step vi.

26. The method for manufacturing a coated cooking element according to claim 22, wherein the duration of maintaining the metal substrate, the metal mesh and the film under pressure is less than or equal to 1 minute in step vi.

27. The method for manufacturing a coated cooking element according to claim 26, wherein the duration of maintaining the metal substrate, the metal mesh and the film under pressure is less than or equal to 15 seconds in step vi.

28. The method for manufacturing a coated cooking element according to claim 22, wherein the duration of maintaining the metal substrate, the metal mesh and the film under pressure is comprised between 1 second and 1 minute in step vi.

29. The method for manufacturing a coated cooking element according to claim 28, wherein the duration of maintaining the metal substrate, the metal mesh and the film under pressure is comprised between 2 seconds and 15 seconds in step vi.

30. The method for manufacturing a coated cooking element according to claim 22, wherein the plane of the surface of the upper tool, relative to the plane of the surface of the lower tool, has an angle comprised between 0.01° and 0.5°.

31. The method for manufacturing a coated cooking element according to claim 30, wherein the plane of the surface of the upper tool, relative to the plane of the surface of the lower tool, has an angle comprised between 0.15° and 0.25°.

32. The method for manufacturing a coated cooking element according to claim 22, wherein the lower tool is heated to a temperature comprised between 25° C. and the temperature of the metal substrate at the time of assembly and/or the upper tool is brought to a temperature comprised between 15° C. and 120° C. in step vi.

33. The method for manufacturing a coated cooking element according to claim 21, wherein said metal substrate is an aluminum substrate, a stainless steel substrate or a multilayer metal substrate whose face is made of aluminum alloy or stainless steel.

34. The method for manufacturing a coated cooking element according to claim 21, wherein the surface of the face of the metal substrate has undergone a surface treatment, said surface treatment being a chemical attack, brushing, hydration, sandblasting, shot peening, a physicochemical treatment of the plasma or corona or laser type, a chemical activation or a combination of these different techniques.

35. The method for manufacturing a coated cooking element according to claim 21, wherein the metal mesh is a woven metal mesh or an expanded metal mesh.

36. The method for manufacturing a coated cooking element according to claim 35, wherein the metal mesh is made of stainless steel.

37. The method for manufacturing a coated cooking element according to claim 21, wherein the metal mesh has a thickness comprised between 50 μm and 800 μm.

38. The method for manufacturing a coated cooking element according to claim 21, wherein the attachment of the metal mesh to the face of the metal substrate is obtained by die-stamping to embed said metal mesh at least partially in said face.

39. The method for manufacturing a coated cooking element according to claim 21, wherein the film comprises a single layer comprising one or more semi-crystalline or amorphous thermoplastic polymers forming a cooking face.

40. The method for manufacturing a coated cooking element according to claim 21, wherein said film further comprises one or more layers each comprising one or more semi-crystalline or amorphous thermoplastic polymers.

41. The method for manufacturing a coated cooking element according to claim 21, wherein the semi-crystalline or amorphous thermoplastic polymer(s) of the layer and, where appropriate, of the additional layer(s) of the film, which are identical or different, are selected from the group comprising:
polytetrafluoroethylene (PTFE), tetrafluoroethylene and perfluoropropylvinyl ether (PFA) copolymers, tetrafluoroethylene and hexafluoropropene (FEP) copolymers, polyvinylidene fluoride (PVDF), tetrafluoroethylene and polymethylvinyl ether (MVA) copolymers, tetrafluoroethylene terpolymers, polymethylvinyl ether and fluoroalkylvinyl ether (TFE/PMVE/FAVE), ethylene tetrafluoroethylene (ETFE), and mixtures thereof;
polyarylether ketones (PAEK), including polyether ketone (PEK), polyether ether ketone (PEEK), polyether ketone ketone (PEKK), polyether ether ketone ketone (PEEKK), polyether ketone ether ketone ketone (PEKEKK);
poly(phenylene oxide) (PPO), poly(arylethersulfone) polymers (PAES) including polyethersulfone (PES), polyphenylene ether sulfone (PPSU), poly(arylene sulfides) (PAS) including polyphenylene sulfide (PPS), liquid crystal polymers;
polyamideimide (PAI), polyimide (PI), polyetherimide (PEI), polybenzymidazole (PBI);
and mixtures thereof.

42. The method for manufacturing a coated cooking element according to claim 21, wherein the film further comprises at least one filler and/or at least one reinforcement.

43. The method for manufacturing a coated cooking element according to claim 21, wherein the face of the film facing the face of the metal substrate and with the metal mesh during step vi. has undergone a mechanical or chemical surface treatment.

44. The method for manufacturing a coated cooking element according to claim 21, wherein the thickness of said film is comprised between 5 μm and 500 μm.

45. The method for manufacturing a coated cooking element according to claim 44, wherein the thickness of said film is comprised between 25 μm and 150 μm.

46. A method for shaping a coated cooking element according to claim 21 comprising a step (a) of press-forming the coated cooking element obtained at the end of step vi.

47. The method for shaping according to claim 46 of a coated cooking element further comprising a step (b) of stretching the coated cooking element obtained at the end of step (a).
